(19) United States
(12) Patent Application Publication
(10) Pub. No.: US 2005/0001081 A1
(43) Pub. Date: Jan. 6, 2005

(54) Document destroyer

(75) Inventor: Helmuth Maier, Uberlingen (DE)

Correspondence Address: AKERMAN SENTERFITT, P.O. BOX 3188, WEST PALM BEACH, FL, 33402-3188, US

(73) Assignee: Martin Yale International GmbH, Markdorf/Bodensee (DE)

(21) Appl. No.: 10/865,600

(22) Filed: Jun. 10, 2004

(30) Foreign Application Priority Data
Jun. 12, 2003 (DE) DE 10326950.9

(51) Int. Cl. B02C 18/22

(52) U.S. Cl. 241/236

(57) ABSTRACT

A description is given of a document destroyer (11) which has a cutting unit (32). In order for documents which are to be destroyed, such as paper sheets (34), to be fed in as precisely rectilinear and parallel a manner as possible, a supply guide (14) with a supply shaft (16) and a supply channel (17) running therein may be designed to be flat, such that the paper cannot crumple or buckle laterally. Furthermore, the width of the supply channel (17) should only be minimally more, for example, than the width of a normal page as used, for example, for copiers. Rectilinear infeed may also be ensured as a result.

### APPLICATION AREA AND PRIOR ART

The invention relates to a document destroyer having a supply guide for introducing documents, for example paper sheets, which are to be destroyed by a cutting unit or the like.

DE 197 42 754 A1 involves the problem where, in the case of a document destroyer with skewed paper infeed, either it is no longer possible to maintain a predetermined cutting width or it is possible for a cutting unit to be obstructed and blocked. This is remedied in the abovementioned document by the fact that, on the sides of the cutting unit, the cutting discs are spaced apart from one another by a relatively narrow distance. This possibility, however, cannot be extended as desired to smaller cutting-disc thicknesses. A further remedy has to be provided if paper sheets are to be destroyed or shredded extremely finely overall without the abovementioned disruption as a result of documents being fed in in a skewed or crushed state.

### OBJECT AND SOLUTION

The object of the invention is to provide a document destroyer of the type mentioned in the introduction by means of which it is possible to eliminate the problems of the prior art and to achieve, in particular, good paper feed and/or a desired particle or cut-material width or particle size for documents which are to be destroyed.

This object is achieved by a document destroyer as described in claim 1. Advantageous and preferred configurations of the invention form the subject matter of the rest of the claims and are explained in more detail hereinbelow. The wording of the claims is with express reference made a content of the description.

According to the invention, it is provided that the supply guide by means of which documents can be guided to the cutting unit or some other destroying device, for example a combustion chamber, forms a channel. This channel is closed by walls on four longitudinal sides. It is also elongate and flat. The length and flatness of the channel are related in that the length is at least a quarter of the width and is relatively flat for this purpose. Furthermore, the flat channel has two narrow walls which are located opposite one another and are spaced apart from one another by essentially the same distance or are parallel, at least in the bottom or rear region of the channel. Two further walls located opposite one another are broad, in particular broader than the narrow walls by a multiple. They are likewise spaced apart by the same distance or are parallel to one another, at least in the bottom or rear region of the channel.

In particular two of the walls at the start of the channel are designed such that they open or curve open in the outward direction, or that a larger access opening to the channel is achieved. It is thus advantageously possible to increase the channel cross section at the start in order to facilitate the supply of documents or paper sheets.

It is thus possible to provide a channel which is sufficiently large at the start, or in the front region, in order for it to be possible to supply documents which are not arranged fully parallel to one another. Longitudinally, however, the channel should assume the flat and broad cross section by way of which the paper sheets or documents which are to be supplied are aligned precisely parallel to one another.

It is thus possible for the documents which are to be destroyed to be guided up to the cutting unit or the means of destroying them in a precisely rectilinear manner. It is thus possible for the problems of paper sheets being displaced to the side, and thus problems in the peripheral region, not to arise in the first place.

Apart from the starting region of the channel, it is possible for the two pairs of opposite walls to be spaced apart from one another in each case by the same distance or to be parallel. This starting region of the channel, which, in particular, may have the widening, may be less than half the channel length, preferably less than a third of the same. Furthermore, it is advantageously provided that the length of the channel is at least 40% to 50% of the width of the channel. The length of that region of the channel which has a constant width or constant cross section should be at least a third of its width. This makes it possible to achieve reliable alignment of the paper sheets guided in the channel. The walls may be closed or provided with openings, for example small holes. It is thus possible to improve sliding properties of paper in certain circumstances.

In a further configuration of the invention, it may be provided that the channel width or the channel cross section can be changed. For this purpose, it is possible to adjust, in particular, a narrow channel wall since the width of paper sheets which are to be supplied is determined thereby. A displacement of a channel wall or a change in the channel cross section should take place by parallel displacement such that the entire channel width is reduced by the same amount. It is thus possible to maintain a good supply action.

The opening or increase in the channel cross section at the start of the channel or of the supply guide may be a multiple of the rest of the channel cross section, preferably two times to ten times the same. This ensures that it is possible for documents which are to be destroyed to be supplied quickly, reliably and without high outlay. This is because even the operation of supplying documents which are to be destroyed into the channel is also important for the following alignment of the paper sheets. An increased access opening may also be achieved in that the top, in particular also a lateral, wall is designed to be a few centimeters shorter than the others.

On the one hand, it is possible for the channel to run essentially rectilinearly. As an alternative to this, it is possible for the channel to be curved in one direction. For this purpose, the narrow walls are advantageously curved, in particular curvature of the channel running downward in the supply direction. It is also possible to provide a slight curvature which alternates a number of times in opposite directions, similar to a corrugation. This allows dimensional stabilization of paper sheets in relation to displacement or crushing in the lateral direction.

The channel of the supply guide advantageously slopes in relation to the horizontal. An angle may be between 30° and 60°, advantageously around approximately 50°. The paper can thus slide down of its own accord. It is also possible for this slope to be varied by a rotatable or tiltable supply channel.

The supply guide may be produced from plastic, preferably PVC. It may also be produced from metal, depending on the application area.

It is further advantageously provided that the direction of the channel runs perpendicularly to the axes of rotation of a cutting unit and thus perpendicularly to an essentially linear location at which the shredding takes place. This allows the documents to be shredded as precisely as possible.

In a further configuration of the invention, it may be provided that the supply guide is designed in a moveable manner. It can thus be moved away from a cutting unit in order to free the latter so that documents which are to be destroyed can be introduced in a conventional manner without the supply guide. Movement capability is advantageously provided in the form of a rotary movement. The supply guide can thus be swung away along an axis of rotation. The axis of rotation advantageously runs parallel to the cutting shafts or the axes of rotation thereof.

Provision may be made for a further supply device to be provided beneath the supply guide. This further supply device may advantageously be designed to correspond essentially to a conventional supply hopper of the document destroyer. This further supply device can be used to supply documents which need not be guided precisely. If this further supply device has a considerably larger cross section than the previously described supply guide, it is possible here to simplify to a considerable extent the operations of destroying and feeding documents which are less of a security priority.

In a further configuration of the invention, it is possible for a document destroyer to be provided with a plurality of such supply guides according to the invention with a very flat channel. It may be provided in particular here that the channel heights are also graduated, for example from an extremely shallow channel height of approximately 1 mm to a somewhat less shallow channel height of 4 mm to 5 mm. It is also generally possible to realize heights of 10 mm to 20 mm. Either it is possible for these supply guides to be swung into a respective operating position and utilized correspondingly or, as an alternative, they may be designed in an essentially stationary manner and moved, for example rotated, into a certain position in which they feed paper sheets to the cutting unit.

These and further features can be gathered not just from the claims, but also from the description and the drawings, it being possible for the individual features to be realized in each case on their own or together in the form of subcombinations in an embodiment of the invention and in other areas and to constitute advantageous and in themselves protectable configurations, for which protection is claimed here.

### BRIEF DESCRIPTION OF THE DRAWINGS

An exemplary embodiment of the invention is explained in more detail hereinbelow and illustrated schematically in the drawings, in which:

FIG. 1 shows an oblique view of a supply guide according to the invention for a document destroyer, and

FIG. 2 shows a lateral sectional illustration through the top part of a document destroyer according to the invention with a swing-action supply guide.

### DETAILED DESCRIPTION OF THE EXEMPLARY EMBODIMENT

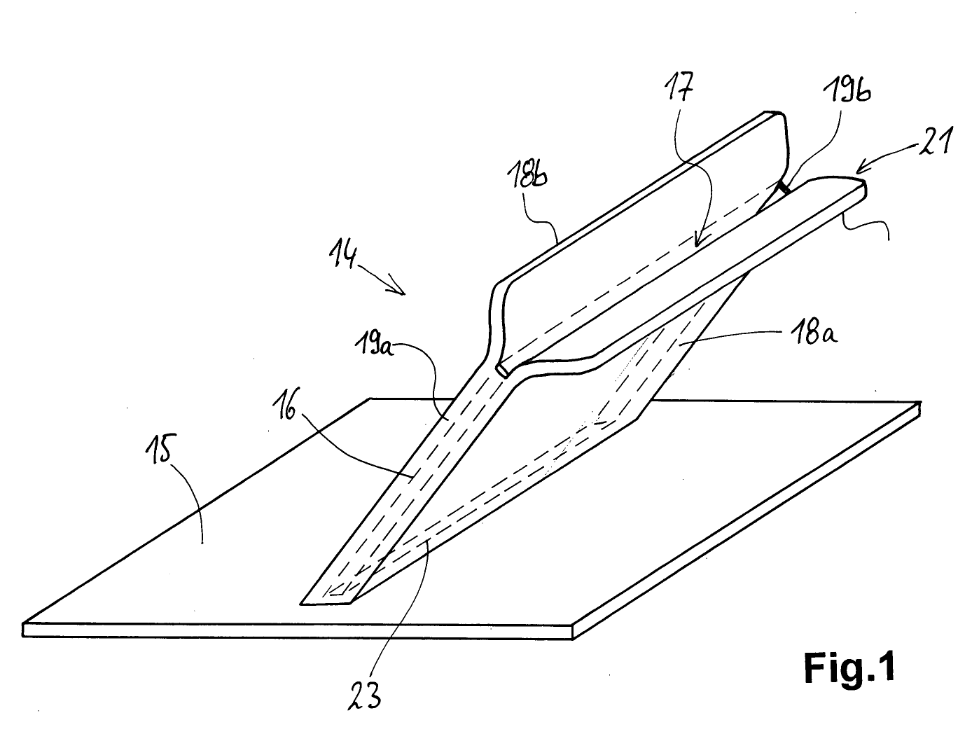

FIG. 1 shows a supply guide 14 according to the idea of the invention in an oblique view from above. A supply shaft 16 slopes upward, to be precise approximately at an angle of 50°, from an essentially planar base plate 15. The supply shaft 16 has an inner supply channel 17. The supply channel 17 is formed, on the one hand, by a broad channel wall 18a, 18b at the top and bottom, respectively. On the other hand, narrow channel walls 19a and 19b are located laterally. This gives a supply channel 17 of rectangular cross section.

In the upward direction, the supply shaft 16 has a hopper-like opening 21. This is achieved by end sections of the broad channel walls 18a and 18b being curved open to a pronounced extent. Starting from the region up to which the narrow channel walls 19 extend, the broad channel walls 18 run parallel to one another in the downward direction, and the supply channel 17 has a constant cross section there.

In the direction of the underside, the supply channel 17 has a narrow outlet slot 23. Documents which are to be destroyed, and have been supplied into the hopper-like opening 21, pass out through this outlet slot in the downward direction.

In FIG. 1, the supply channel 17 is illustrated by dashed lines essentially along its edges. It can also be seen from this how the supply channel 17 is designed to be very flat in relation to its width. It is possible for the width, as is illustrated in FIG. 1, to be unchangeable, with all the channel walls formed rigidly. In this case, the width is advantageously equal to a common paper size, for example corresponding to the width of a DIN A4 sheet. It is also possible, however, for the width to be adjustable, for example by way of a narrow displaceable channel wall 19.

The height of the channel 17 may be in the range of a few millimeters. The height should not be too great, in particular, in order that the paper (34) supplied has as little space as possible in which to crumple or deviate in some other way from the straight path.

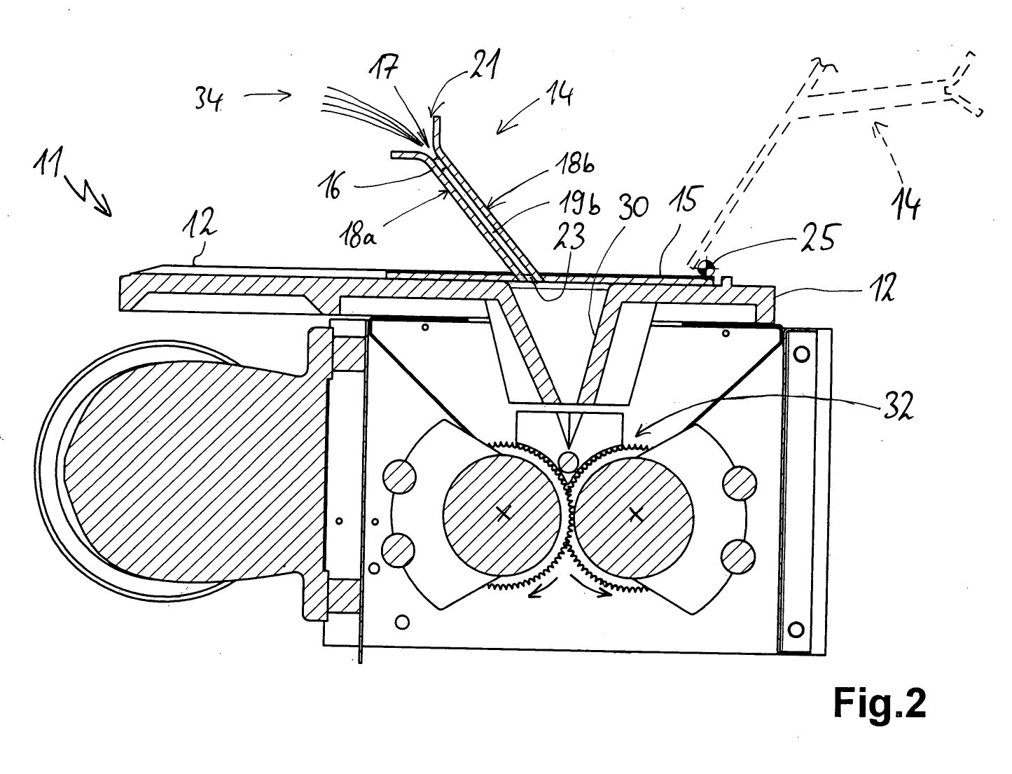

FIG. 2 shows how the supply guide 14 is positioned on a document destroyer 11 according to the invention or on the top housing side 12 thereof. As can be seen, the supply guide 14 can be pivoted upward about the axis of rotation 25 provided at the right-hand end. This pivoting can take place, for example, into the position which is illustrated by dashed lines. Further details in this respect are given hereinbelow.

The supply device 30 is located beneath the supply guide 14. This supply device 30 corresponds essentially to a conventional supply device for such a document destroyer 11. It can be seen how the cutting unit 32 is arranged beneath the supply device 30. This cutting unit 32 likewise corresponds to a conventional document-destroyer cutting unit. In particular for applications where the security and comminution of the documents which are to be destroyed have to meet stringent requirements, the cutting unit may be designed correspondingly, for example with very narrow cutting grooves or the like. However, other comminuting devices or paper-destroying devices are also conceivable.

### FUNCTION

The supply guide 14 according to the invention, which is illustrated in FIGS. 1 and 2, has the advantage that, by virtue of the supply channel 17 being designed with, in particular, a constant-width cross section over a relatively long length, it arranges the documents which are to be destroyed, and are supplied from above, essentially precisely parallel to one another. This forced parallel guidance is achieved and maintained, in particular, by the certain length of the supply channel 17 or of the supply guide 14, which is considerably longer than in the case of known document destroyers. As a result, documents 34 which are to be destroyed are aligned in a precisely parallel manner and pass into the cutting unit 32 in a precisely predetermined direction. This makes it possible to avoid skewed infeed arising during cutting. Such skewed infeed is also to be regarded as very negative, in particular, because, as has been explained in the introduction, it may result overall in an unequal cutting width or an unequal particle length or comminution in respect of particle size. An unequal cutting width, in turn, does not satisfy predetermined security regulations. Furthermore, it is more easy to avoid blockage of the cutting unit by laterally accumulated paper material or the like.

The height of the supply channel 17 may be in the range of a few millimeters, although it may also be as much as from 10 mm to 20 mm. It is also determined, in particular, by the cutting performance of the document destroyer as a whole and/or of the cutting unit 32. For a number of, for example, 25 sheets of paper of normal paper thickness, a height of four or five millimeters is sufficient. This relatively low height avoids the situation where individual sheets of paper crumple and thus deviate from the precisely predetermined alignment.

In order to make it easier for documents which are to be destroyed to be supplied into the relatively narrow supply channel 17, the hopper-like opening 21 or, in general terms, a widening is provided. In addition, or as an alternative, to the broad channel walls 18 being curved open, it is also possible for the narrow channel walls 19 to be similarly curved open. Curving the broad channel walls 18 open, in contrast, provides, overall, a supply cross section of considerably larger surface area, and is preferred in this respect.

As an alternative to the rectilinear design of the supply guide 14 or of the supply channel 17 illustrated, it is also possible for the latter to be curved one or more times about an axis of curvature which should be located parallel to the outlet slot 23. On the one hand, such curvature can improve the behavior of paper sheets as they slide in or are fed in through the cutting unit 32. In addition, such a curved configuration makes it possible for a sheet of paper which is located in the supply channel 17 to be stabilized in relation to buckling or displacement. This is due to the fact that it has been found, within the context of the invention, that a flat paper sheet has less stability in a direction transverse to its surface area. If, in contrast, a sheet of paper is curved slightly, it is already possible to achieve a certain amount of stability. A paper sheet which is stabilized in such a way is not so easily skewed or crushed or displaced in an undesirable direction during infeed. This is regarded as being advantageous. A similar effect can be observed, albeit to a far more pronounced extent, with so-called corrugated sheet metal. This is likewise stabilized to a considerable extent by corrugation or curvature.

In the case of a curved supply guide 14, the latter would be curved in the upward or downward direction in side view, in an illustration similar to that from FIG. 2.

It can be gathered from the illustration in FIG. 2 how, with the supply guide 14 swung upward and/or away, the document destroyer 11 can be utilized like a normal document destroyer without the special supply guide. A further configuration of the invention may also provide for a plurality of such supply guides 14 with a flat cross section or shallow supply-channel height. It would be possible for these supply guides to be offset in a fan-like manner in relation to one another on the top side of the document destroyer and to be oriented toward the cutting unit 32. A graduation of the channel heights of the respective guide makes it possible, in dependence on the quantity of documents which are to be destroyed and thus on the thickness of the paper stack which is to be supplied, to select such a supply channel which has only a slightly greater height. This makes it possible to achieve the intended rectilinear infeed with the greatest possible level of reliability.

As an alternative to a document destroyer 11 being designed according to FIG. 2, it is possible to use an above described supply guide with essentially any type of document destroyer. It is also possible to use different types of cutting unit, for example also multiple cutting units or the like.

In the case of the preferred possibility, it is thus possible to provide a document destroyer which has a cutting unit. In order for documents which are to be destroyed, such as paper sheets or the like, to be fed in as precisely rectilinear and parallel a manner as possible, a supply guide with a supply shaft and a supply channel running therein may be designed to be flat, such that the paper cannot crumple or buckle laterally. Furthermore, the width of the supply channel should only be minimally more, for example, than the width of a normal page as is used, for example, as copier paper. Other formats are, in some circumstances, also country-dependent. Rectilinear infeed is also advantageously ensured as a result.

1. A document destroyer having a supply guide for introducing documents or paper sheets which are to be destroyed, and having a cutting unit for destroying said documents, said supply guide forming a channel, wherein said channel:
is closed by four walls on four longitudinal sides,
is elongate with a length and a width, said length being at least a quarter of said width,
is flat,
has two narrow walls located opposite one another which are essentially parallel to one another, at least in a bottom region of said channel,
has two broad walls located opposite one another which are spaced apart from one another by essentially the same distance or are parallel to one another, at least in said bottom region of said channel.

2. The document destroyer as claimed in claim 1, wherein two of said walls at the start of said channel curve open in the outward direction in order to increase a channel cross section.

3. The document destroyer as claimed in claim 1, wherein, apart from the starting region of said channel, said two pairs of opposite walls are parallel to one another in each case.

4. The document destroyer as claimed in claim 1, wherein said length of said channel is at least 50% of said width of said channel.

5. The document destroyer as claimed in claim 1, wherein said width of said channel is adjustable by way of at least one narrow adjustable channel wall.

6. The document destroyer as claimed in claim 5, wherein said adjustable channel wall can be adjusted exclusively by parallel displacement.

7. The document destroyer as claimed in claim 2, wherein said cross section of said curved-open start of said channel is a multiple of the cross section of the rest of said channel.

8. The document destroyer as claimed in claim 1, wherein said channel runs essentially rectilinearly.

9. The document destroyer as claimed in claim 1, wherein said channel is curved and has curved narrow walls.

10. The document destroyer as claimed in claim 9, wherein said curved narrow walls are curved such that they hang downward.

11. The document destroyer as claimed in claim 1, wherein said channel slopes in relation to the horizontal.

12. The document destroyer as claimed in claim 1, wherein a direction of said channel is perpendicular to the axes of rotation of said cutting unit.

13. The document destroyer as claimed in claim 1, wherein said width of the channel is less than 30 cm or said height of said channel is less than 1 cm.

14. The document destroyer as claimed in claim 1, wherein said supply guide is designed in a moveable manner such that it can be moved away from said cutting unit in order to free said cutting unit so that said documents which are to be destroyed can be introduced past said supply guide.

15. The document destroyer as claimed in claim 14, wherein said supply guide can be swung away about an axis of rotation, said axis of rotation running parallel to the axes of rotation of said cutting unit.

16. The document destroyer as claimed in claim 13, wherein a further supply device by means of which said documents which are to be destroyed are supplied to said cutting unit is arranged between said supply guide and said cutting unit.

17. The document destroyer as claimed in claim 16, wherein said further supply device has a considerably larger cross section than said other supply guide.
